(19) United States
(12) Patent Application Publication
(10) Pub. No.: US 2006/0225663 A1
(43) Pub. Date: Oct. 12, 2006

(54) Reptile housing structure

(76) Inventor: Michael Chiang, Hsin-Chuang City (TW)

Correspondence Address: BIRCH STEWART KOLASCH & BIRCH, PO BOX 747, FALLS CHURCH, VA, 22040-0747, US

(21) Appl. No.: 11/093,284

(22) Filed: Mar. 30, 2005

(51) Int. Cl. A01K 1/03

(52) U.S. Cl. 119/452

(57) ABSTRACT

A reptile housing structure allows users to assemble by themselves. It includes a bottom chest for housing breeding reptiles and amphibians and required goods, three side panels and a face panel to be coupled on the bottom chest, and an upper lid coupled on the upper edges of the three side panels and the face panel. This invention uses a small size glass and may be disassembled and packaged. The glass is less likely to be broken, thus can save cost. The package size also is smaller, thus can save transportation space and reduce transportation cost.

### FIELD OF THE INVENTION

The present invention relates to a reptile housing structure and particularly to a structure for breeding reptiles and amphibians and reducing packaging size.

### BACKGROUND OF THE INVENTION

Housing for breeding reptiles is known in art. For instance, R.O.C. Patent No. M256067 entitled “Housing structure for aquatic animals and reptiles” includes a glass bowl for housing aquatic animals and reptiles, a frame mounted onto the upper periphery of the glass bowl that has a stepwise housing area extended inwards, a lid coupled on the frame that has a spacer net located in the center and a fastening member on one side to fasten to one side of the frame. The frame and the lid may be assembled and coupled to allow the glass bowl to house aquatic animals and reptiles. However, the structure is bulky after assembled. After packaging, the housing space in the frame has only about 20% of the total size to hold other elements. As a result, vendors have to allocate a large warehouse to store the finished products. For shipping the product, it wastes a lot of container space. Moreover, the glass has a great area and is easily broken when the finished products are stored in the warehouse or during shipping. All this increases product cost.

All of aforesaid problems occurred to the conventional techniques still are not effectively resolved heretofore. Some vendors try to take passive approaches to overcome those problems. For instance, some make smaller bowls to be held in the housing space of the frame to save package space. Some produce reinforced materials to guard the glass and prevent the glass from being broken. However these approaches incur additional costs.

### SUMMARY OF THE INVENTION

Therefore the primary object of the present invention is to provide a structure that can reduce the package size of the finished product to save the space of warehouses and containers, and reduce the cost of transportation when the product is shipped.

The reptiles and aquatic animals generally do not need much water like fishes in the aquarium. Hence the present invention adopts a design that enables users to assemble by themselves. The reptile housing structure according the invention includes a bottom chest for breeding reptiles and amphibians and necessary goods, a hollow coupling lid located on an upper edge of the bottom chest that has a coupling trough on the periphery, posts mounted onto four corners of the coupling lid with each post having four surfaces on a long side and a jutting ridge on each of two neighboring surfaces, a side panel which has two opposite sides to couple with the jutting ridges and mounted on a coupling trough formed on the coupling lid, a face panel which has two opposite sides to couple with the ridge of the posts and mounted on the coupling trough of the coupling lid, and an upper lid which has four sides to be coupled with the upper edges of the side panel and face panel.

Another object of the invention is to provide a smaller glass area, or hold the glass in a safe manner after disassembled so that breaking or damaging is minimized in the warehouse or during transportation to reduce costs.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a perspective view of the present invention.

FIG. 1B is a sectional view according to FIG. 1A.

FIG. 2A is an exploded view of the present invention.

FIG. 2B is a fragmentary enlarged view of FIG. 2A.

FIG. 3A is a perspective view of the present invention with the side panels made from glass.

FIG. 3B is a sectional view according to FIG. 3A.

FIG. 4 is a schematic view of an embodiment of the present invention in a stacked condition.

FIGS. 5 and 6 are schematic views of various embodiments of the present invention formed in varying sizes.

### DETAILED DESCRIPTION OF THE PREFERRED EMBODIMENTS

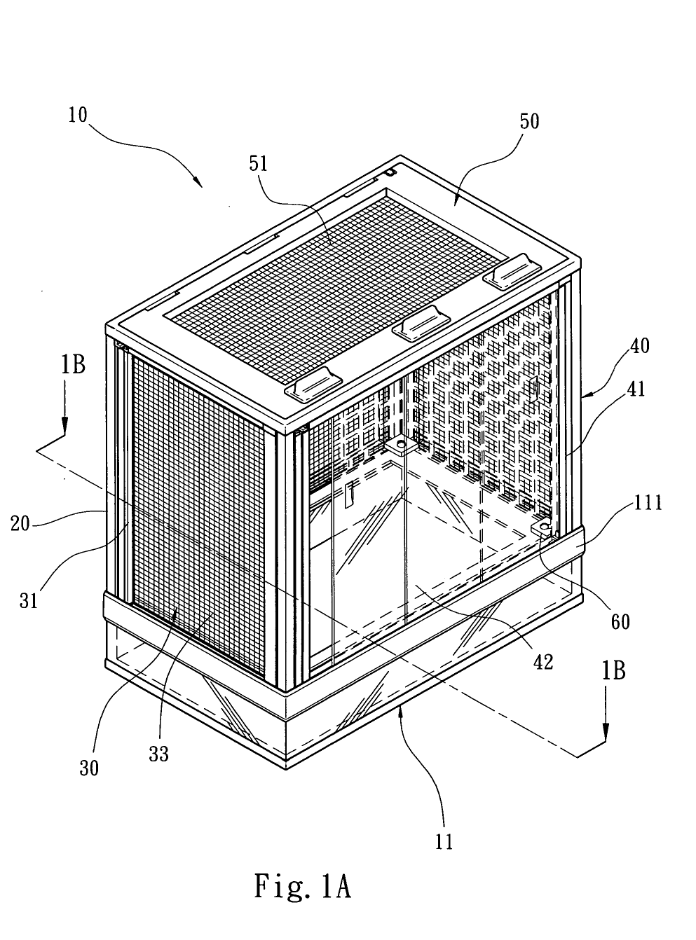

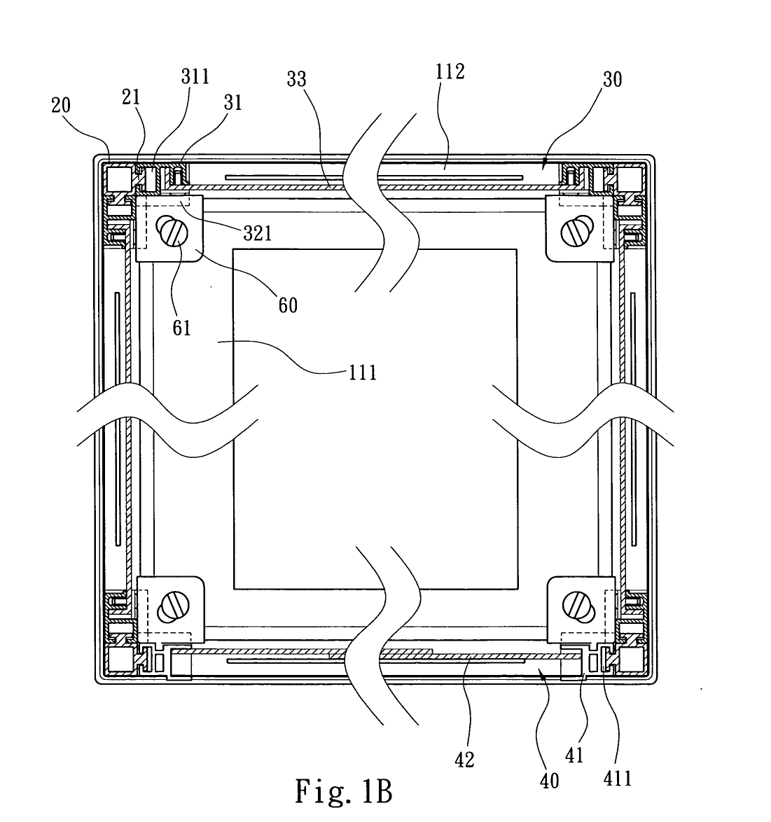

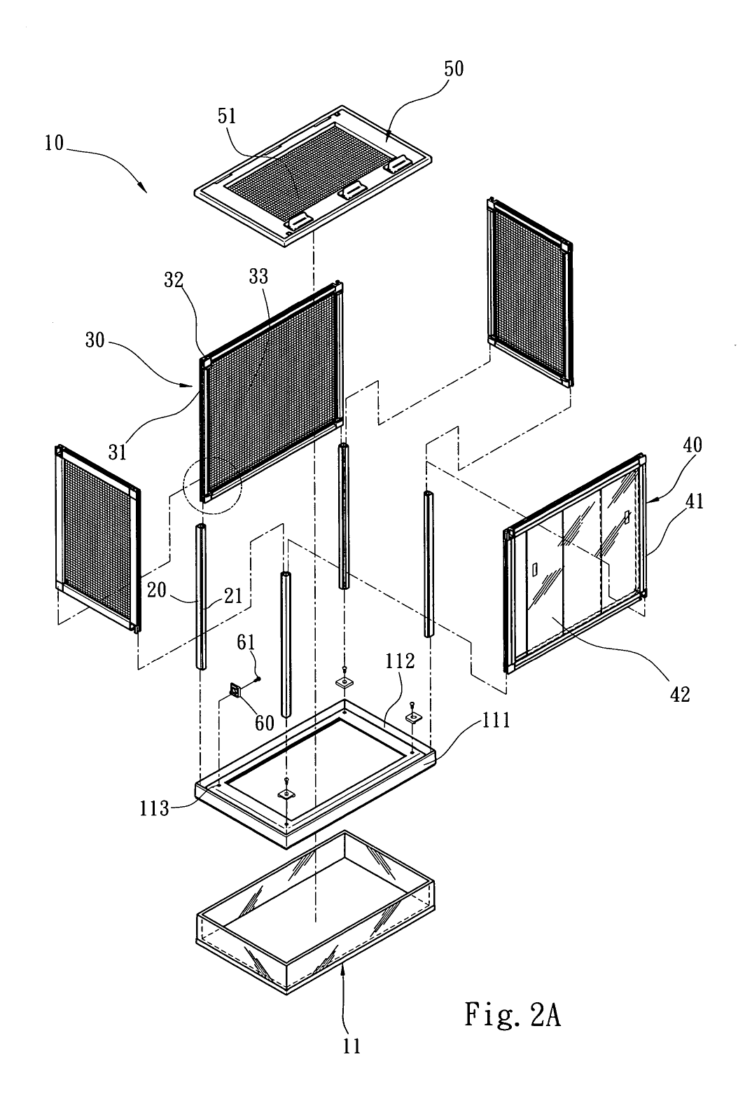

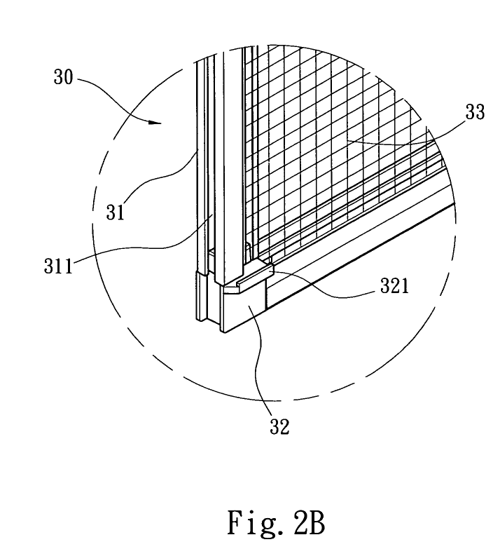

Please refer to FIGS. 1A through 2B, the reptile housing structure according to present invention includes a bottom chest 11 for breeding reptiles and amphibians and necessary goods. There is a hollow coupling lid 111 mounted onto the upper edge of the bottom chest 11. The coupling lid 111 has a coupling trough 112 on the periphery. The coupling lid 111 has four corners and each has a fastening aperture 113. The four corners of the coupling lid 111 are coupled with posts 20 and each has four surfaces on a long side. Two of neighboring surfaces of each post have respectively a jutting ridge 21. There are side panels 30 and each has two opposite sides coupled with the jutting ridge 21 and mounted on the coupling trough 112 of the coupling lid 111. The side panel 30 has four sides and each may be formed in a frame 31. The edge of the frame 31 may have a frame trough 311 mating and engageable with the jutting ridge 21 of the post 20. Moreover, two frames 31 are joined on a juncture to be coupled and fastened by a frame connector 32. The frame connector 32 has a fastening end 321 fastened by a fastening plate 60 which is run through by a fastening element 61 to engage with the fastening aperture 113 of the coupling lid 111. The fastening plate 60 has one end compressing the fastening end 321 to anchor the frame connector 32. The rectangular area formed by the frames 31 may hold a spaced net 33 to provide a desired ventilation effect. On the front side, as the reptiles and amphibians need only a small amount of water, sands and wooden chips on the bottom chest 11, a face panel 40 is provided. The face panel 40 has two opposite sides mating and coupled with the jutting ridges 21 of the posts 20, and also is engaged with the coupling trough 112 of the coupling lid 111. The face panel 40 may also be coupled with face frames 41 on four sides. The juncture of two face frames 41 is fastened by one frame connector 32. The frame connector 32 has a fastening end 321 fastened by one fastening plate 60 which has one end engaged with the aperture 113 of the coupling lid 111. The fastening plate 60 has one end compressing the fastening end 321 to anchor the frame connector 32. The rectangular area formed by face frames 41 may hold two sliding glass doors 42 that may be opened and closed as desired. As the sliding doors 42 are made of transparent glass, owners can see the breeding reptiles and amphibians clearly from the front end. It also provides indoor ornamental effect. The face panels 41 may also be coupled with a spacer net 33 to enhance ventilation, or a piece of glass. To prevent the reptiles and amphibians from running out, an upper lid 50 is provided to cover the reptile housing 10. The side panels 30 and face panel 40 have an upper edge to couple with four sides of the upper lid 50. The upper lid 50 may also be designed as a ventilation door 51 so that owners can open the upper lid 50 to feed the reptiles and amphibians.

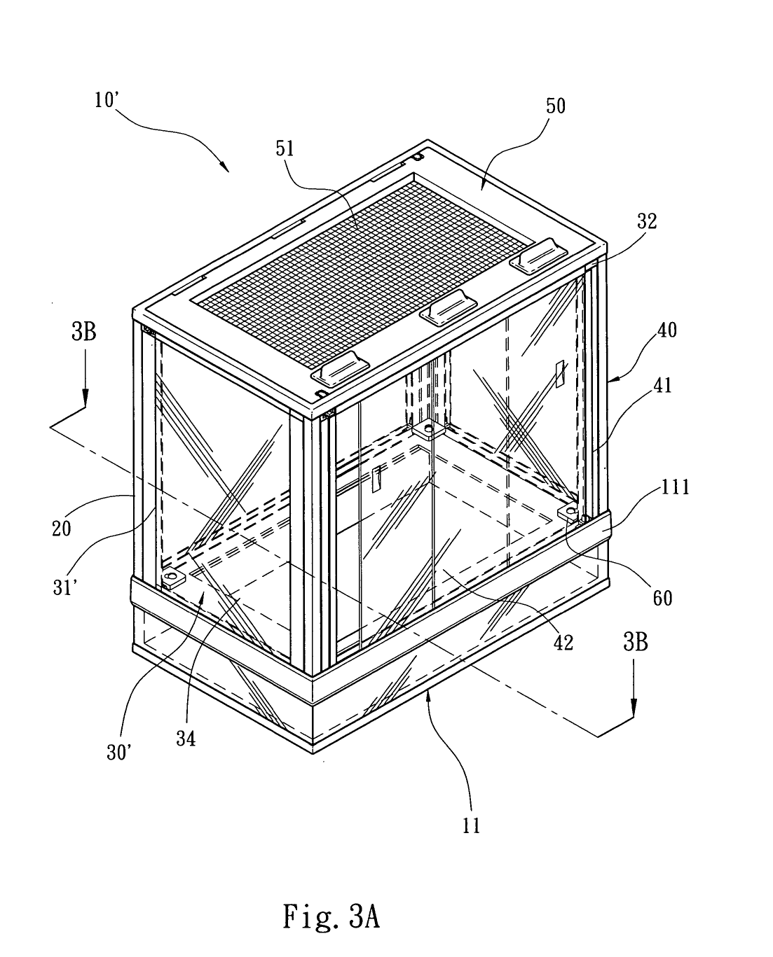

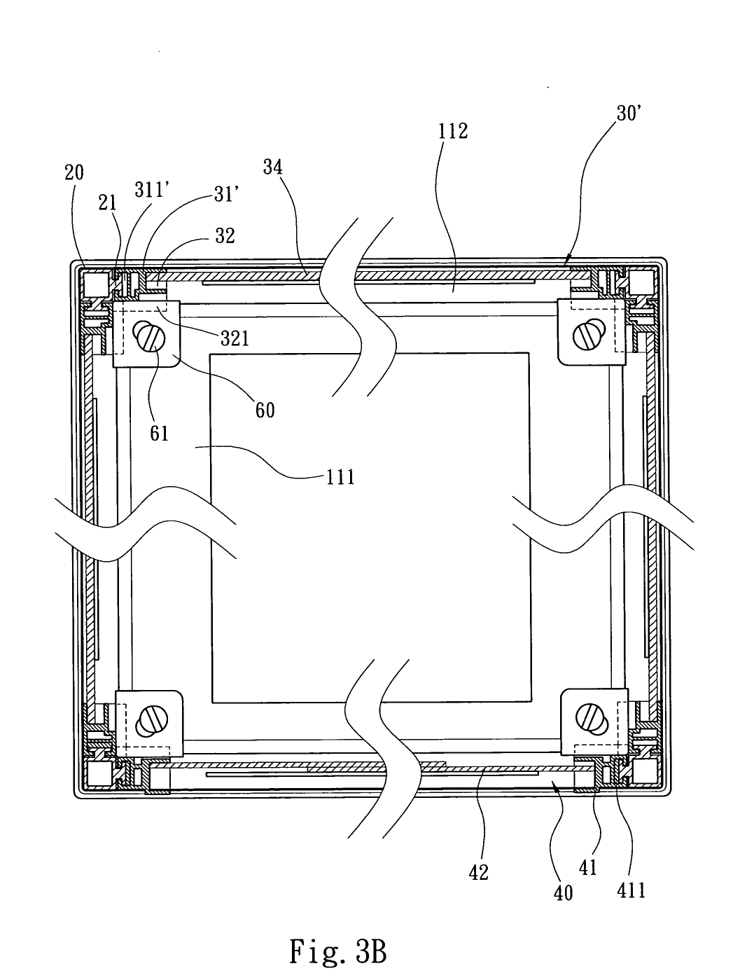

Refer to FIGS. 3A and 3B for another embodiment that has glass side panels. It is constructed largely like the one previously discussed. However, the four sides of the side panel 30′ can be coupled with frames 31′ and each has a frame trough 311′ on a lateral side mating and engageable with the jutting ridge 21 of the post 20. The rectangular area formed by the frames 31′ may be coupled with a transparent glass 34.

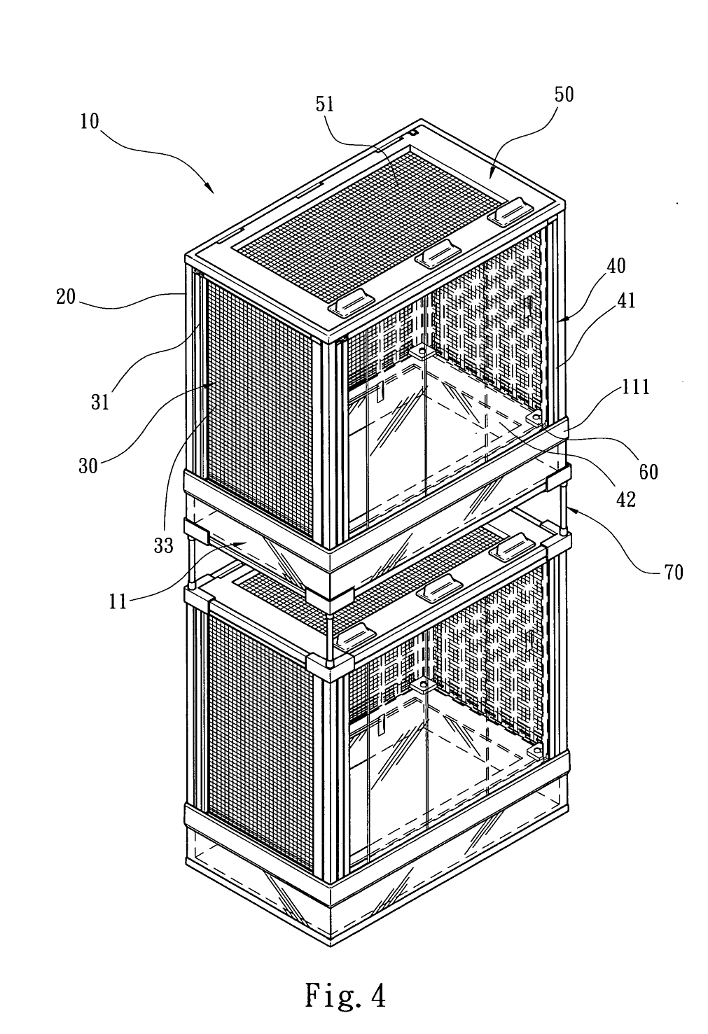

As there are many types of pets people want to raise, and available space in the house is limited, to remedy this problem, the breeding chest often provides a stacking structure to enable the breed chests that house different pets to be stacked together. FIG. 4 illustrates such a structure that has bracing racks 70 to stack the housing of the invention.

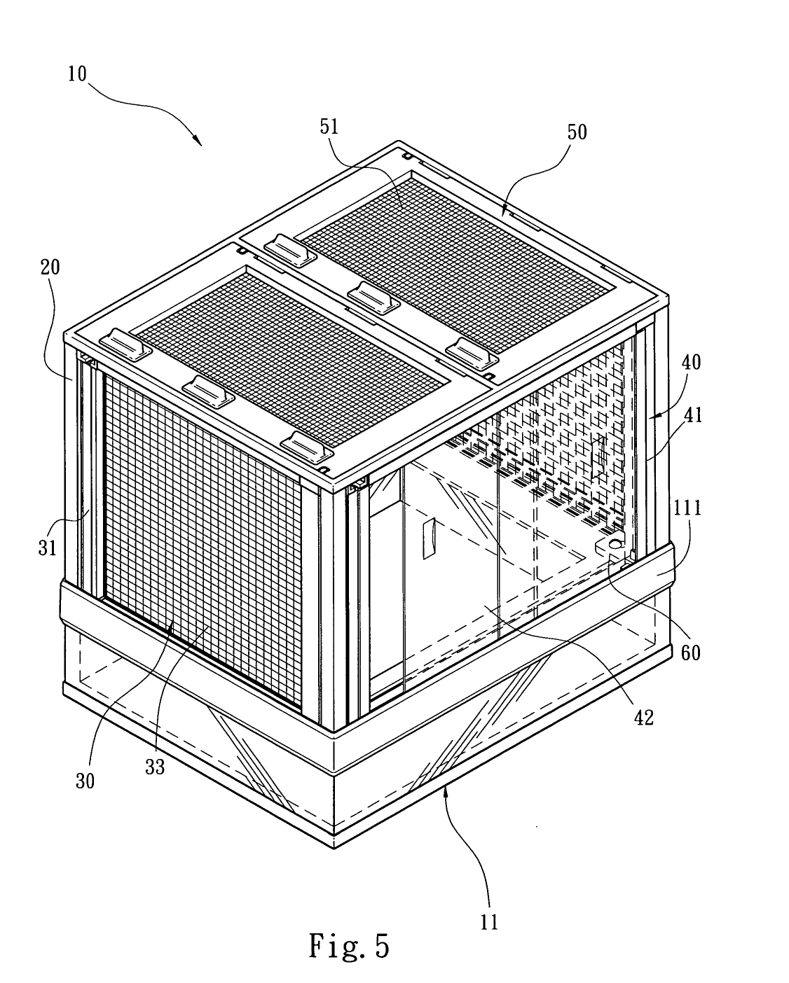

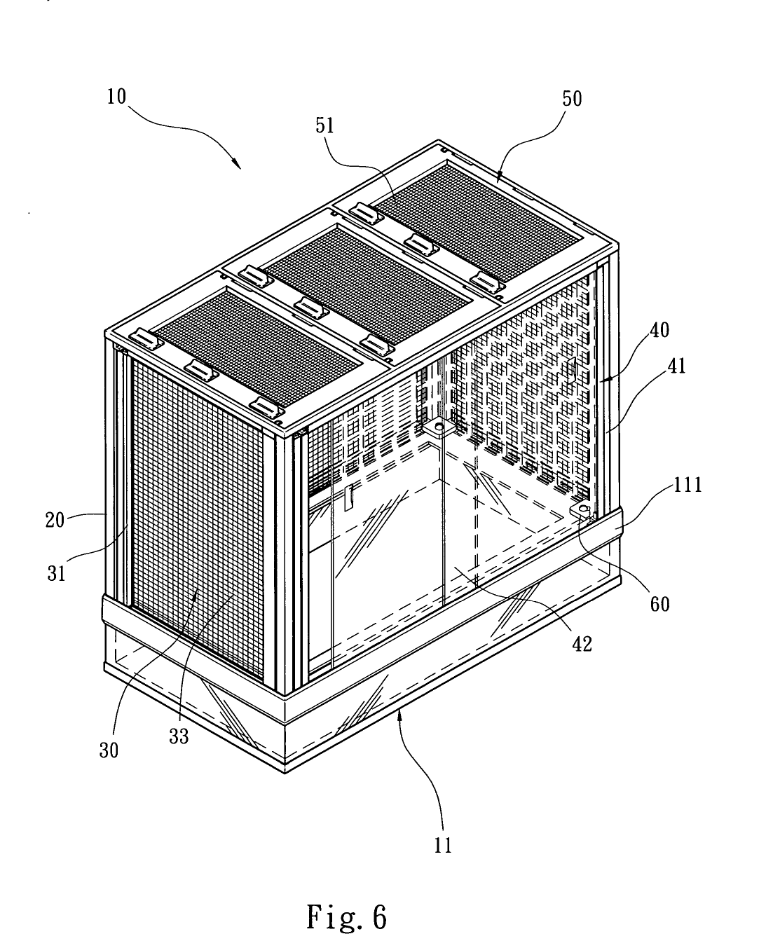

Refer to FIGS. 5 and 6 for other embodiments of the invention that are constructed in different sizes. A larger reptile housing 10 aims to breed the reptiles and amphibians of a larger size. In such a situation, two or three upper lids 50 may be provided. For feeding, only one upper lid 50 needs to be opened. This can resolve the problem occurred to the conventional techniques which have one big and heavy upper lid 50 that is difficult to open and remove. As the general reptiles and amphibians need only a small amount of water, sands and wooden chips on the bottom chest 11, the face panel 40 may contain two sliding glass doors 42 that are slidable leftwards and rightwards without the need of lifting the upper lid 50. The sliding doors 42 are made from transparent glass, thus owners can see clearly the breeding reptiles and amphibians from the front side. It also provides indoor ornamental effect.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A reptile housing structure, comprising:
a bottom chest for housing breeding reptiles and amphibians and required goods having an upper edge to couple with a coupling lid which is hollow and has a coupling trough on the periphery;
posts to couple with four corners of the coupling lid having respectively four surfaces on a long side and a jutting ridge on each of two neighboring surfaces;
a side panel which has two opposite sides to couple with the jutting ridge and the coupling trough of the coupling lid;
a face panel which has two opposite sides to couple with the jutting ridge and the coupling trough of the coupling lid; and
an upper lid which has four sides mating and coupling with upper edges of the side panel and the face panel.

2. The reptile housing structure of claim 1, wherein the coupling lid has a fastening aperture on each of the four corners.

3. The reptile housing structure of claim 1, wherein the side panel has a frame on each of four sides, the frame having a frame trough on a lateral side to couple with the jutting ridge, two neighboring frames being joined on a juncture which is fastened by a frame connector to anchor the frames, the frame connector having a fastening end.

4. The reptile housing structure of claim 3, wherein the fastening end has a fastening plate to be run through by a fastening element to engage with the fastening aperture of the coupling lid.

5. The reptile housing structure of claim 3, wherein the frames hold a spacer net.

6. The reptile housing structure of claim 3, wherein the frames hold a piece of glass.

7. The reptile housing structure of claim 1, wherein the face panel has a face frame on each of four sides, the face frame having a frame trough on a lateral side to couple with the jutting ridge, two neighboring face frames being joined on a juncture which is fastened by a frame connector to anchor the face frames.

8. The reptile housing structure of claim 7, wherein the face frames hold a pair of sliding doors.

9. The reptile housing structure of claim 7, wherein the face frames hold a spacer net.

10. The reptile housing structure of claim 7, wherein the face frames hold a piece of glass.

11. The reptile housing structure of claim 1, wherein the upper lid has a ventilation door.
